(19) United States
(12) Patent Application Publication
(10) Pub. No.: US 2007/0214154 A1
(43) Pub. Date: Sep. 13, 2007

(54) Data Storage And Retrieval

(76) Inventors: Gery Ducatel, Suffolk (GB); Benham Azvine, Suffolk (GB)

Correspondence Address: NIXON & VANDERHYE, PC, 901 NORTH GLEBE ROAD, 11TH FLOOR, ARLINGTON, VA, 22203, US

(21) Appl. No.: 11/578,833

(22) PCT Filed: Jun. 10, 2005
(86) PCT No.: PCT/GB05/02306

§ 371 Date: Oct. 19, 2006

(30) Foreign Application Priority Data
Jun. 25, 2004 (GB) 0414332.7

(51) Int. Cl. G06F 17/30

(52) U.S. Cl. 707/100

(57) ABSTRACT

A data repository stores data items with associated metadata values (21, 22 . . . 27), together with associated relatedness values (212, 217, 227) etc, defined between each pair of metadata values. In order to retrieve data, a ‘most relevant’ metadata value (21) is identified and data items associated with that metadata value are retrieved first. Other data items are ranked according to the relatedness value (217) of their associated metadata value (27) to the selected metadata value (21).

This invention relates to data storage and retrieval processes, and a means for performing the processes using a computer. Data retrieval commonly makes use of search tools known as “browsers” or “search engines”. To be effective, these need to present a simple user interface, whilst using highly complex information-retrieval technology in the background. An ideal system would allow a user to retrieve all the information he requires using a single, simple, search field, with no “false drops” (data items which are not relevant to the user despite meeting the search criteria). In practice, this is not achievable, as a balance has to found between defining search criteria sufficiently precisely that all information retrieved is relevant, or defining them broadly enough for all relevant information to be retrieved. Most search engines have provision for a search to be refined if the initial criteria are set too narrowly or broadly.

In the event of a search being defined too broadly, navigation of the result list itself is a significant task. The search may be refined by the user—essentially repeating the process on the more limited database defined by the initial search result. However, to do so inevitably risks losing some data that does not meet the more limited search criteria. It is therefore desirable that the user can inspect the initial search results. This can be facilitated by the structure by which the results are arranged, which should preferably present the data most likely to be required by the user within the first few entries in the result list.

Various ways are known for ranking search results according to their likely relevance. The data items may be ranked according to the relationships, in each retrieved item, between the terms used in the search. For example, items in which two keywords appear adjacent to each other in text may be ranked above items where the same two keywords appear further apart. Other methods include ranking the items in order of the number of times the items are accessed, or some other measure of popularity such as the method used by the “Google” RTM search engine that uses the number of references (hyperlinks) made to each individual site.

Another method used by Google is to subordinate entries that are deemed very similar to another one already listed, thereby increasing the variety of data items appearing in the first few entries. However, this ranking method assumes that the differences between the data item displayed and a subordinate one are not significant for the user's particular purposes.

All these measures of popularity increase the likelihood, for the majority of users, that they will find what they are looking for in the first few entries. However, they will be less successful for those, albeit a minority, who are looking for less commonly required data items.

Various attempts have been made to improve results using further input from the user, such as by dialogue during the search process, or by reference to a user profile stored in advance. However, these techniques do not analyse the nature of the data being searched, but require further input from the user.

For data sets whose size is bounded, and in particular a set whose data capture is controlled, it is common to organise the data in a hierarchical structure, allowing searches to be restricted to a given class or layer of the structure. An example of this is the International Patent Classification key, used to assist retrieval of information from the millions of patent specifications that have been published in a wide variety of languages over the past 150 years or so. However, sorting an entire data set for each query using conventional information retrieval techniques, such as a relevance-weighting algorithm, would be too computationally complex to allow a search result to be delivered in a reasonable time. Moreover, the conventional hierarchical structure requires initial assumptions to be made, whereas a given individual search may require data items to be found which exist on different branches of the structure but are related in a way not relevant to the structure used. For example, if a hierarchical structure is based on utility, items related by having common origins (manufacturers), composition or components, may occur in very different parts of the database.

According to the invention, there is provided a process for constructing a data repository, comprising the steps of

defining a set of metadata values

defining a relatedness value between each pair of metadata values

assigning one or more of the metadata values to each of a plurality of data items to be stored by the repository, and

providing means for retrieving the data items grouped according to their assigned metadata values and the relatedness of the metadata values to each other.

The invention extends to a data repository ordered according to these principles, more specifically a data repository having means for storing data items and associated metadata values, and means for storing associated relatedness values, defined between each pair of metadata values, and comprising means for retrieving the data items and their assigned metadata values, and means for presenting the data items grouped according to their assigned metadata values and the relatedness of the metadata values to each other.

Also according to the invention, there is provided a process for retrieving data from a repository constructed as defined above, comprising the steps of:

running a search for data items having one or more predetermined characteristics;

identifying the metadata value most relevant to the data items meeting the search criteria;

ranking the other metadata values in order of their relatedness to the first value,

and presenting the data items according to the ranking of their associated metadata values.

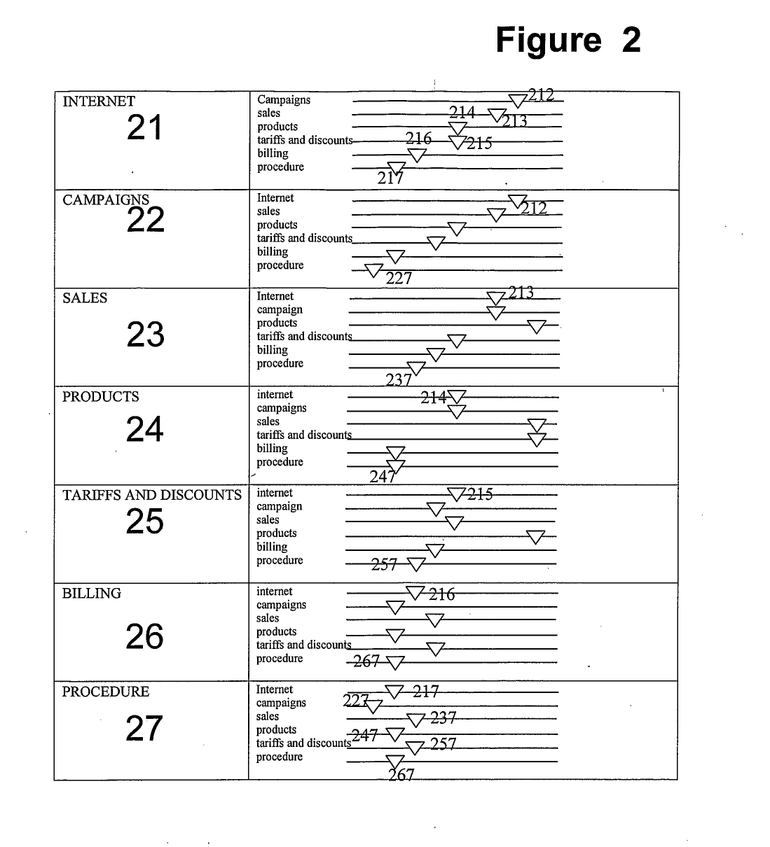

The invention can be used for data sets with a hierarchical structure, typically of a size that is too big to search exhaustively, but small enough for data capture to be practical. A system operating according to the invention re-orders hierarchically classified data, and presents it to the operator for quick and intuitive browsing. The data to be presented is pre-processed by a “fuzzy logic” process defining a measure of likeliness of relevance, and the data is then ranked accordingly. This allows data to be grouped according to the associated metadata, each group being ranked in order of its likely relevance to the searcher. Instead of filtering out information that is identified by the search engine as being less likely to be relevant, the data set is presented in its entirety, but re-ordered such that the most relevant data appears first. Thus, data items without the selected metadata category are nevertheless also listed in the search result, but are given a low ranking according to the relatedness between the metadata category defined by the search and that allocated to the data item. That relatedness may be defined as a distance in a virtual space, as illustrated in FIG. 2. The virtual space may have as many dimensions as necessary to represent the relationships between the metadata, each dimension relating to a property, and the co-ordinate of each metadata item in that dimension being defined by the relevance of each item to that property. The properties may be defined in many ways. For example, they may be defined in terms of the overlap in the use of keywords used in each category, such keywords either having been inserted deliberately, or occurring in the natural language of the document. Depending on the nature of the data, other useful metadata properties that indicate relatedness may include authorship, synonyms (whether from the same or different languages), date of creation, etc.

This invention allows the computer's ability to handle data structures and dynamic re-ranking to be combined with the ability of operators to browse through the data using cognitive reasoning. A searcher can identify groups of data items likely to be of interest, making it easier to determine which items are worthy of consideration. For example, if as a result of a search a number of items having a particular metadata term are observed to be less relevant than their ranking might suggest, the fact they are grouped together allows the user to readily identify and disregard all items grouped with that term.

From a computational point of view the invention allows the system to pre-calculate the distance between two sets—referred to herein as the “semantic difference” between the various categories and keeps the ability to re-order them at low cost given a specific query.

In a preferred arrangement, the metadata is displayed with the search results. Users can therefore relate the metadata to the search process, allowing them to build up experience of the classification taxonomy, thereby assisting both in development of the current search, and in approaching future searches.

An embodiment of the invention will now be described, by way of example, with reference to the drawings, in which

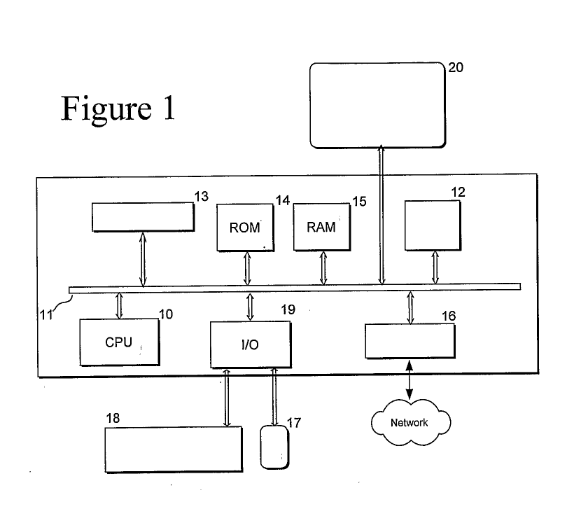

FIG. 1 is a schematic diagram of the general arrangement of a computer system suitable for performance of the invention

FIG. 2 illustrates the application by each metadata category of relative weightings to each other metadata category

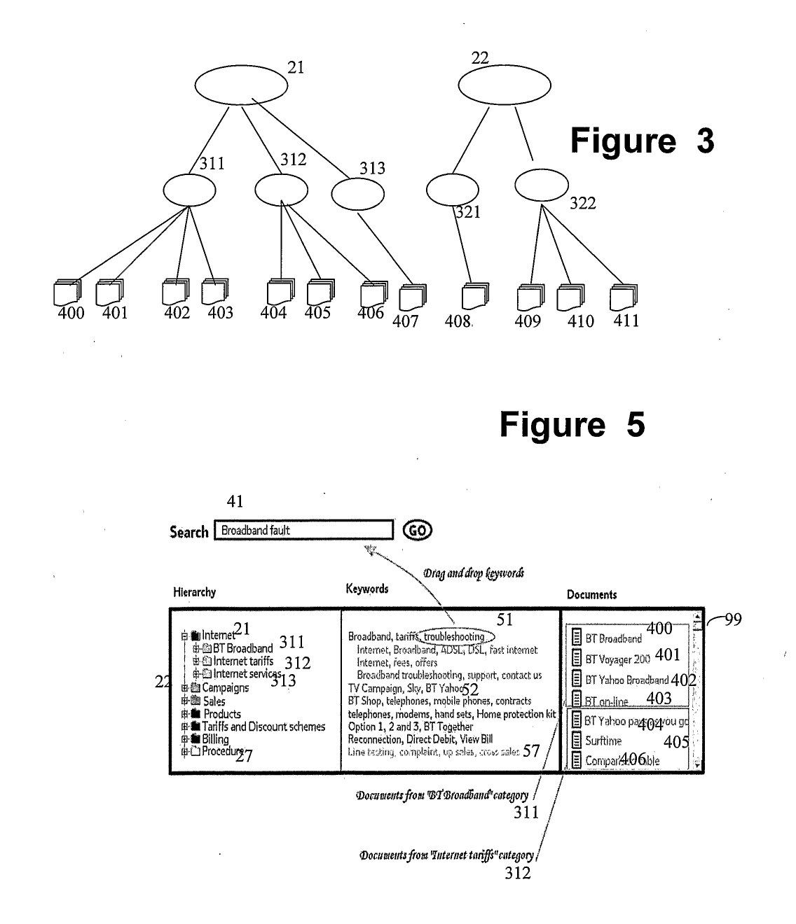

FIG. 3 is a representation of categories using the metadata

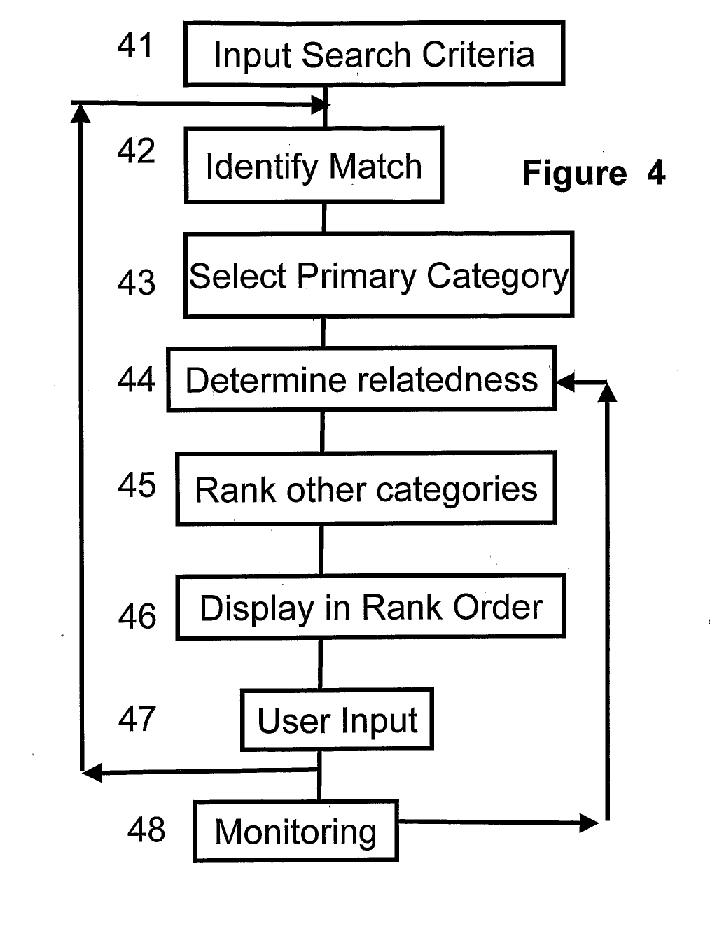

FIG. 4 is a flow diagram representing the search process

FIG. 5 is a screen shot illustrating a search result

A typical architecture for a computer on which software implementing the invention can be run, is shown in FIG. 1. Each computer comprises a central processing unit (CPU) 10 for executing computer programs and managing and controlling the operation of the computer. The CPU 10 is connected to a number of devices via a bus 11, the devices including a first storage device 12, for example a hard disk drive for storing system and application software, a second storage device 13 such as a floppy disk drive or CD/DVD drive for reading data from and/or writing data to a removable storage medium and memory devices including ROM 14 and RAM 15. The computer further includes a network card 16 for interfacing to a network. The computer can also include user input/output devices such as a mouse 17 and keyboard 18 connected to the bus 11 via an input/output port 19, as well as a display 20. The skilled person will understand that this architecture is not limiting, but is merely an example of a typical computer architecture. The computer may also be a distributed system, comprising a number of computers communicating through their respective interface ports 16 such that a user may access program and other data stored on one computer using his own user interface devices 17, 18, 20. It will be further understood that the described computers have all the necessary operating system and application software to enable it to fulfil its purpose.

A data set to which the invention is to be applied has a hierarchical data structure containing metadata. The metadata may be provided by using an ontology, (that is to say, the specification of a conceptualisation of the data), but a more conventional data hierarchy structure would also be suitable for the task, such as a hierarchical labelled taxonomy, as shown representatively in FIG. 3. Individual categories (21, 22), have subclasses (nodes) 311, 312, 313; and 321, 322, and individual documents 400, 401, 402, . . . 411, allocated to these nodes. The data items contain keywords. Automated methods may be used to extract keywords from the data items, thereby allowing the elements at each level of the hierarchy to be populated with metadata. Alternatively, manual methods may be used where accuracy is essential.

Each metadata category 21, 22 etc is then allocated a position in a multidimensional space. Therefore, given one category, it is possible to measure and order all the other categories in terms of their proximity in that space to the first category.

FIG. 2 illustrates how selection of a given category affects the ordering of the remaining ones. For each category 21, 22, . . . 27, a set of relationships with the other categories is determined, and the results are displayed here as markers on a scale—thus marker 217 indicates the relatedness between categories 21 and 27. (This value is of course the same for both the relatedness of category 27 to category 21, and vice versa). It will be seen that for the first category 21 (“Internet”), the category 23 (“sales”) scores higher than the category 26 (“billing”), as indicated by their respective markers 213, 216 and will therefore be ranked for relevance in that order when category 21 is selected as most relevant. Conversely, when “Procedure” (category 27) is selected, “billing” ranks higher than “sales”, as indicated by their respective markers (267, 237)

When a search is to be performed on the data, the user first defines the search criteria (step 41—see also FIG. 5). To perform a search in the database, one of the metadata categories may be specified e.g. “Internet” (21). This may be done in conventional manner by selecting a term from an on-screen menu such as that depicted in FIG. 5. Alternatively, a keyword or other search term may be specified. The search processor identifies matches with these criteria, and the search process returns the node in the data structure that best matches the search term, or preferably a list of documents associated with such a node (step 42). A primary category is then selected (step 43) on the basis of the category allocated to the data items which best match the search term. Specifically, this is the category to which are allocated the largest number of data items selected by the search. This category 21 is displayed first in a data hierarchy display, as shown in FIG. 5 (step 46). Based on the attributes of the selected category, “fuzzy matching” techniques are then used to determine the order in which all the other categories should be ranked. This process assesses the relevance of each category to the user query (step 44) using a vector-based measurement, such as tf.idf (an index that removes “stop” words and works out the statistical importance of every word; this value is used as a relevance weighting for every indexed word)

The ordering can be influenced by the terms specified in the query itself. It is possible to measure how relevant a word is to a category. For example the phrase “broadband promise” may cause the “Internet” category 21 to be selected as the most relevant category because of the high relevance of the word “broadband”. It is then possible to rank the other categories (step 45) using the values given by the Fuzzy re-ranking process, which do not require a user query. It is also possible to see how relevant this query is to other categories. In this example the user may consider the “campaign” category 22 relevant to the query because of a new advertisement campaign. It is possible to re-rank the entire data structure to account for this temporary relevance. Therefore re-ranking takes two values into account to measure the distance between two categories: 1) the pre-processed ranking, 2) a ranking based on the user query.

The present embodiment provides a multiple view of the data retrieved by the search engine, allowing browsing to be performed by various intuitive means in whatever way seems most appropriate to the user. As shown in FIG. 5, the data is presented according to a hierarchical structure (21-27) a keyword list (51-57) and a document list (400, 401, 402, etc). By identifying the keywords in each category, and the label and metadata for that category, the user can understand how the words used in the initial query are used in those categories. So for instance “broadband” and “fault” are keywords that may occur in the category “Internet”, and also in the category “procedure”, based on the query context and, based on the respective contexts, the user may decide to explore one category or the other.

The display (FIG. 5) shows the category (21) identified as most relevant at the top of the left hand column. The interdependency seen for FIG. 2 is based on vector comparisons. One can represent a document with a vector, where the elements are keywords. These keywords are weighted with an algorithm (tf.idf is standard). Therefore it becomes possible to measure the distance between any two documents or document sets. The addition of metadata allows the correction of any misinterpretation of this statistical method. The Fuzzy Sets model the interdependencies between all the categories. It is helpful to represent all these inter-related categories in a more understandable way; FIG. 2 helps visualising these relationships.

Metadata (keywords) 51 associated with this category in the hierarchy are displayed in the middle column. This is cognitive information for the operator, to indicate what the query words mean in the context of the selected category.

Below the top category 21, other categories 22, 23, 24, 25, 26, 27 and corresponding keywords 52, 53, 54, 55, 56, 57 are listed in order of their relatedness to the first selected category 21. The hierarchy presented in the first column is derived, according to the invention, according to the relatedness between the category 21 identified by the search results as being closest to the user's search requirements, and each of the other categories 22, 23, 24, 25, 26, 27 etc. In this example “Internet” (21) has been identified as the primary category, and, as shown in FIG. 2, “campaigns” (22) is shown as the category having the highest weighting (greatest proximity) and is therefore listed second.

The display also allows the display of hierarchical data. In FIG. 5, three categories 311, 312, 313, are indented in column 1 under “Internet” (21). These subcategories are ranked in the same way as the main categories, with the subcategory 311 the most relevant to the search query listed first and the other subcategories 312, 313 listed in order of relatedness to that first subcategory. Metadata relevant to the subcategories is displayed as for the main categories.

The “fuzzy logic” technology allows the user to identify inter-dependencies between the concepts in the taxonomy, and to extract relevant semantic information by looking at the keywords 51, 52, etc to get a feel for the meaning of the query in the context of the different categories. This allows the users to perform complex queries using positive and negative keywords. The keywords are manually entered in the initial query 41, but the search engine can then suggest more keywords 51, 52 etc for the operator to choose in order to facilitate refinement of the query The keywords 51, 52 reflect the semantic meaning of a category. They may simply be synonyms or contextually related to the query. This metadata can also influence the search result by providing complementary vocabulary.

To browse the keywords, the user selects relevant keywords in the “semantic” list (51, 52, . . . 57)—step 47, This causes the re-ordering of the taxonomy (step 42-46 repeated) to reflect the semantic importance of the chosen keywords. More specific keyword selection such as product names can be performed. This would return all possible locations (in the data taxonomy) for the retrieved documents.

The keywords 51 relate to the selected category 21, but may not be relevant to the initial query that returned that category. Keywords that are related to the query may be identified by highlighting, or by the order in which the keywords appear.

The user may also “browse” through the taxonomy itself 21, 311, 312, 313, 22, etc. The system monitors the user's activities (step 48), allowing the meaning of the original query to be derived from the categories that the user selects, This information is then fed back to weigh the semantic information specific to the search, allowing further potential matches to be identified.

The third column in FIG. 5 displays the results 400, 401, etc of the search for one or more categories 21, 22, etc or subcategories 311, 312, etc that the user selected, arranged in the same order as the categories themselves are listed. As there would typically be several documents 400, 401, 402, in any given category or subcategory, this list will be very much longer than the lists of categories 21-27, subcategories 311-313 and keywords 51-57 in the other columns, and a scroll bar 99 is provided to allow the full list to be seen. Means such as colour coding or background shading may be provided to distinguish groups of documents 400-403, 404-406 belonging to different categories or sub-categories 311, 312, assisting the user to browse the individual documents

The initial query can be refined (step 47) by the user, who selects some contextual keywords 52 from the middle column. This query would trigger a re-ranking of, the results (step 42-45), as the associated categories change their order. The selection of contextual keywords thereby allows the user to understand what information is kept under each category, and use this knowledge for later queries.

Provision may also be made for a user, having selected and studied a document, to provide feedback, by allowing a “more like this, or a “wrong topic” feedback mechanism (step 57). Such feedback could be used by the system to enhance or reduce the ranking of a given category.

To take a particular example, the keyword “valve” may appear in many different contexts, such as electronics, pressure sensors, pumps, engines or hydraulics. A user may choose to give positive or negative feedback about each document presented to him depending on whether the technical field of that document is relevant to the one he is concerned with, without having to identify specific keywords which may be too limiting. This would mean that the word “valve” is not a good one to use to re-rank and therefore should be overlooked; upon user feedback the entire data hierarchy can be re-ranked to better model the intended query

As will be understood by those skilled in the art, any or all of the software used to implement the invention can be embodied on any carrier suitable for storage or transmission and readable by a suitable computer input device, such as CD-ROM, optically readable marks, magnetic media, punched card or tape, or on an electromagnetic or optical signal, so that the program can be loaded onto one or more general purpose computers or could be downloaded over a computer network using a suitable transmission medium.

1. A data repository having means for storing data items and associated metadata values, and means for storing associated relatedness values, defined between each pair of metadata values, and comprising means for retrieving the data items and their assigned metadata values, and means for presenting the data items grouped according to their assigned metadata values and the relatedness of the metadata values to each other.

2. A process for constructing a data repository, comprising the steps of
defining a set of metadata values
defining a relatedness value between each pair of metadata values assigning one or more of the metadata values to each of a plurality of data items to be stored by the repository
and providing means for retrieving the data items grouped according to their assigned metadata values and the relatedness of the metadata values to each other.

3. A process for retrieving data from a repository constructed according to claim 1, comprising the steps of:
running a search for data items having one or more predetermined characteristics;
identifying the metadata value most relevant to the data items meeting the search criteria;
ranking the other metadata values in order of their relatedness to the first value
presenting the data items according to the ranking of their associated metadata values.

4. A process according to claim 3, wherein the selection of the most relevant metadata value is determined by the terms specified in the query itself.

5. A process according to claim 3, wherein the query specifies one or more of the metadata values

6. A process according to claim 3, wherein the metadata is displayed with the search results.

7. A process according to claim 6, wherein data items retrieved by the user are identified, and a re-ordering of the metadata values is performed on the basis of the items retrieved

8. A computer program or suite of computer programs for use with one or more computers to or to carry out the method as set out in claim 2.
